(19) United States
(12) Patent Application Publication
(10) Pub. No.: US 2019/0147490 A1
(43) Pub. Date: May 16, 2019

(54) SYSTEMS FOR FACILITATING THIRD-PARTY ART SUBMISSIONS

(71) Applicant: Elwha LLC, Bellevue, WA (US)

(72) Inventors: ALISTAIR K. CHAN, BAINBRIDGE ISLAND, WA (US); ROY P. DIAZ, SEATTLE, WA (US); RODERICK A. HYDE, REDMOND, WA (US)

(21) Appl. No.: 16/248,056

(22) Filed: Jan. 15, 2019

Related U.S. Application Data
(63) Continuation of application No. 13/708,158, filed on Dec. 7, 2012.

(51) Int. Cl. G06Q 30/02

(52) U.S. Cl. CPC G06Q 30/0256

(57) ABSTRACT

A method and for submitting third-party prior art submissions in a patent application to a patent office. The method including receiving a request from a third-party. The request identifies a target patent application. The method further includes publishing an advertisement for a prior art search relating to the target patent application. The method includes receiving an indication from a search party that the search party will perform the prior art search. The method includes receiving a first prior art document from the search party. The method includes submitting a package of documents to the patent office, wherein the package of documents includes the first prior art document and a statement of relevance.

### BACKGROUND

Companies often monitor patent databases to identify relevant patent applications filed by other parties. In some situations, the company may wish to participate in the examination of a patent application filed by another party. For example, the company may know of relevant prior art references and may wish to submit the references to the United States Patent and Trademark Office (USPTO) for consideration by the patent examiner.

The rules for third-party prior art submissions for pending applications in the USPTO have been revised to reflect statutory changes made by the America Invents Act (AIA). In particular, 37 C.F.R. § 1.290 allows a third-party to make a submission of potential prior art references to the USPTO for a published patent application prior to the mailing of a notice of allowance or the later of six months after the application's date of publication or the date of a first rejection of any claim by the examiner under 37 C.F.R. § 1.104. The rules further require that a submitting party must provide, among other items, a list identifying each submitted document, a description of the relevance of each submitted document, a copy of each non-U.S. patent and U.S. patent application publication, and English translations for foreign language documents.

### SUMMARY

One exemplary embodiment relates to a method and system for submitting third-party art submissions in a patent application to a patent office. The method includes receiving a request from a third-party. The request identifies a target patent application. The method further includes publishing an advertisement for an information search relating to the target patent application. The method includes receiving an indication from a search party that the search party will perform the prior art search. The method includes receiving a first information from the search party. The method includes submitting a set of information to the patent office, wherein the set of information includes the first prior art document and a statement of relevance.

Another exemplary embodiment relates to a method of submitting third-party art submissions in a patent application to a patent office. The method includes receiving a request from a third-party. The request identifies a target patent application. The method further includes auctioning a art search relating to subject matter of the target patent application. The auctioning includes receiving a first bid from a first search party and a second bid from a second search party. The second bid is lower in price than the first bid. The method includes selecting the second search party and receiving a first reference from the second search party. The method further includes submitting a set of references to the patent office. The set of references includes the first reference and a statement of relevance.

A further exemplary embodiment relates to a method of submitting third-party art submissions in a patent application to a patent office. The method includes receiving a request from a third-party. The request identifies a target patent application. The method further includes collecting a fee from the third-party. The method includes receiving a reference from a search party and submitting the reference to the patent office. The method includes monitoring prosecution of the target patent application and identifying a correspondence from the patent office pertaining to the target patent application. The method includes paying the search party a bonus if the reference was cited in the correspondence.

Yet another exemplary embodiment relates to a method of advertising third-party art submission services to a potential customer. The method includes determining a category of patent applications of interest for a third-party. The method further includes locating a target patent application relating to the category and alerting the third-party that the target patent application exists. The alerting does not disclose an identification of the target patent application. The method further includes receiving a request from the third-party to submit a reference to the patent office.

Another exemplary embodiment relates to a system. The system includes a third-party request module including circuitry configured to receive a request from a third-party, wherein the request identifies a target patent application. The system further includes a solicitation module including circuitry configured to publish an advertisement relating to the target patent application. The solicitation module also includes circuitry configured to receive an indication from a search party that the search party will perform an art search. The system includes a submission module including circuitry configured to receive reference information from the search party. The submission module also includes circuitry configured to generate electronic submission information and to transmit the electronic submission information to a patent office. The electronic submission information includes at least one of reference information and relevance information.

A further exemplary embodiment relates to non-transitory tangible computer-readable storage media with computer-executable instructions embodied thereon that when executed by a computing system perform a method of facilitating a third-party prior art submission to a patent office. The computer-readable media includes instructions for receiving request information from a third-party, wherein the request identifies a target patent application. The computer-readable media further includes instructions for generating search request information relating to the target patent application. The computer-readable media includes instructions for receiving an indication from a search party that the search party will perform an art search. The computer-readable media further includes instructions for receiving reference information from the search party. The computer-readable media includes instructions for generating electronic submission information for transmission to the patent office, wherein the electronic submission information includes at least one of prior art information and relevance information.

The invention is capable of other embodiments and of being carried out in various ways. Alternative exemplary embodiments relate to other features and combinations of features as may be generally recited in the claims.

The foregoing is a summary and thus by necessity contains simplifications, generalizations, and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE FIGURES

FIG. 1 is a block diagram view of a third-party prior art submission system according to an exemplary embodiment.

FIG. 2 is a flow diagram overview of a method of operating the system of FIG. 1.

FIG. 3 is a schematic view of a display screen listing active search requests.

FIG. 4 is a flow diagram describing a prior art search strategy based on using keywords according to an exemplary embodiment.

FIG. 5 is a flow diagram detailing a decision process for paying a search party a reward based on patent office or agency prosecution results according to an exemplary embodiment.

FIG. 6 is a flow diagram describing a patent application monitoring service according to an exemplary embodiment.

FIG. 7 is a flow diagram describing an advertising service based on a patent application monitoring service according to an exemplary embodiment.

FIG. 8 is a flow diagram describing a method of using an automated system for generating and submitting third-party prior art submissions to a patent office or agency according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, systems and methods for facilitating third-party prior art submissions to the USPTO are shown. There are many situations in which a person or a company may wish to submit potential prior art references to be considered by a patent examiner during prosecution of a patent application. 35 U.S.C. § 122(e) entitled “Preissuance Submissions by Third Parties” and 37 C.F.R. § 1.290 entitled “Submissions by Third Parties in Applications” provide the framework for proper third-party submissions in pending patent applications in front of the USPTO. As used in this application, the term “third-party” generally means a person or a company that wishes to submit a prior art reference to a patent office for consideration during prosecution of a target patent application with which the third-party is not an inventor or an assignee of the application.

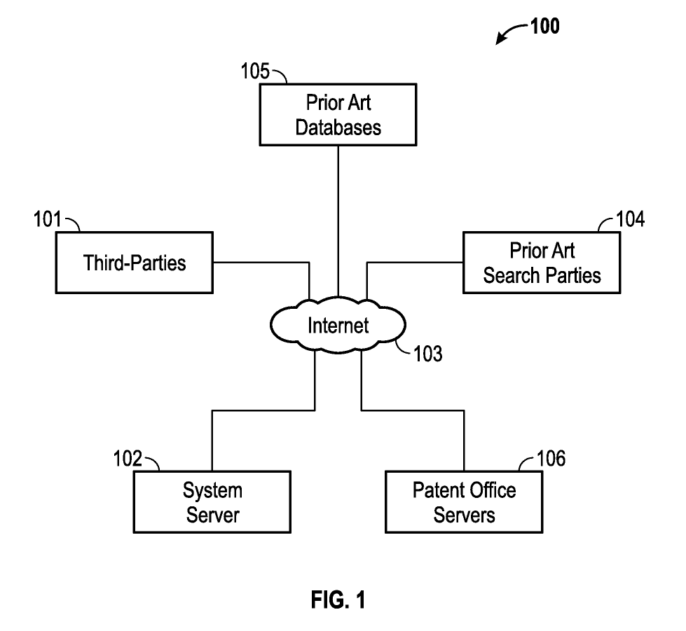

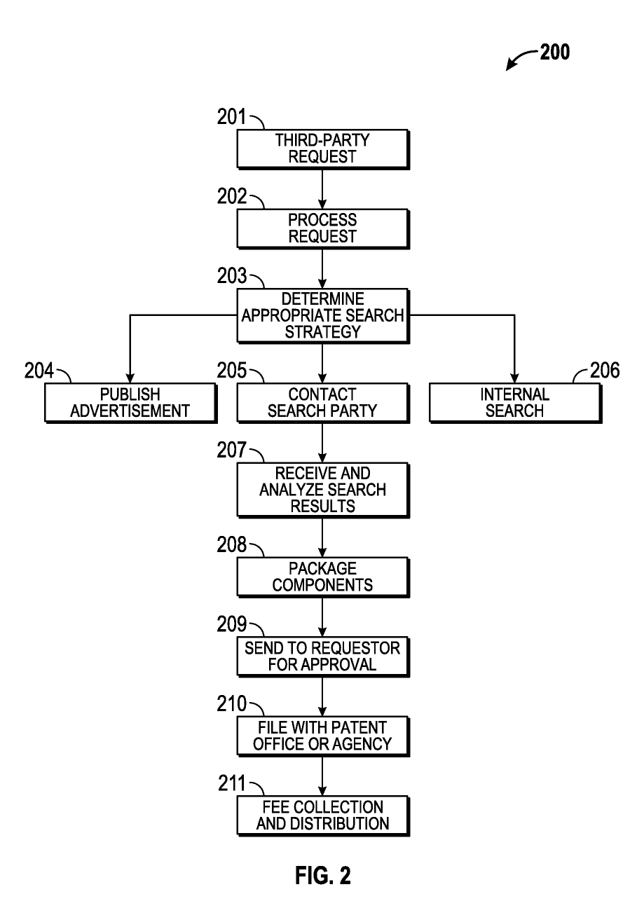

Referring to FIG. 1, a diagram of a system 100 for submitting third-party prior art submissions to a patent office or agency (e.g., the USPTO) is shown. Third-parties 101 connect to system server 102 through a network (shown as the Internet 103). System server 102 is further connected to search parties 104. System server 102 hosts a website configured to provide user-interfaces to third-parties 101 and to search parties 104. Search parties 104 have access to online prior art databases 105. Additionally, system server 102 has access to prior art databases 105. Prior art databases 105 may include: databases containing United States and foreign patent applications and patents, databases containing scholarly articles, databases containing company press releases, databases containing scientific journals, and/or databases containing other media publications. Still further, system server 102 is operatively connected to patent office or agency servers (shown as patent office servers 106) through the Internet 103. Methods of using third-party prior art submission systems, such as system 100, are discussed below with respect to FIG. 2 through FIG. 7.

Referring to FIG. 2, a method 200 of facilitating third-party prior art submissions in patent applications is described according to an exemplary embodiment. A third-party submits a search and submission request (step 201). The request is processed (step 202). The appropriate search strategy is determined based on the request (step 203). If a specifically designated search party is not indicated by the request, an online posting is published to advertise the prior art search to outside search parties (step 204). If the request designates a specific search party, the designated search party is contacted (step 205). If the request designates an automated system keyword prior art search, an internal prior art search is performed (step 206). Regardless of what entity performs the search, search results are received and analyzed (step 207). All necessary and required forms and components, including a statement of relevance, are packaged (step 208). Once the components are packaged, the packaged components are forwarded to the requestor for approval (step 209). Once approval is granted, the packaged components are filed with the appropriate patent office or agency (e.g., the USPTO; step 210). Finally, fees from the requestor are collected and the appropriate portion is distributed to the search party (step 211). The steps of the described method 200 are further described in the following paragraphs and figures.

A requestor, or a party acting on behalf of the requestor, initiates a search and submission request (step 201). The request contains one or more published patent applications for which the requestor would like to locate potential prior art documents for submission to and consideration by the patent office or agency. Further, the request includes any specific prior art documents that are already known to the requestor. The communication of the request is accomplished via a website used to provide information to a system server (e.g., system server 102). Alternatively, the request is submitted via e-mail, fax, telephone submission to an agent, mail submission to an agent, or in-person submission.

The request contains information about the desired services, including the type of search to be performed for the target patent application. For example, the requestor may choose not to designate a specific search party. In such a case, the requestor designates that system 100 publishes an advertisement to attract an outside search party to perform the search (step 204). Alternatively, the requestor may designate a specific outside search firm to be used (step 205). In yet another alternate scenario, the requestor requests that system 100 automatically performs a prior art search based on the system's analysis of the target patent application publications or based on provided keywords (step 206). In any case, the requestor indicates certain parameters of the search to be performed (e.g., what databases to use, what countries to search in, whether non-patent literature should be included, whether a scholarly journal search should be performed, how much time should be spent on the search, etc.).

The request contains information about a desired budget. The requestor may provide a strict budget including any patent office or agency fees. Alternatively, the requestor may select from a set of predetermined packages offered by system 100. The predetermined packages may have different types of search strategies corresponding to the parameters of the prior art search to be performed, including the number of references to be submitted, and/or the amount of human review to be performed. In yet another alternate scenario, the requestor selects that a person search for prior art for a designated amount of time or until a satisfactory prior art reference is located.

Further referring to FIG. 2, after receiving the request, the request is processed (step 202). During processing, the target patent application is identified. System 100 is configured to contact the USPTO or other patent entity to obtain all amendments to the target patent application and all prior communication between the applicant and the patent office or agency (e.g., by polling patent office servers 106). The amendments retrieved are analyzed to determine changes to the target patent application. Further, during processing (step 202) the request is analyzed to ensure that the window for a proper third-party submission has not expired. For example, under the AIA, third-party prior art submissions are allowed prior to the mailing of a notice of allowance or the later of six months after the target application's date of publication or the date of a first rejection of any claim by the examiner. Accordingly, the target application and the target patent application's prosecution is analyzed to determine whether the submission window has expired under the appropriate patent rules. If the time for a proper third-party submission has expired, the requestor is notified of the error and the request is cancelled.

After the processing (step 202) is complete, the appropriate search parties are determined based on the request (step 203). As noted above, requestor can designate a specific search party, an automated system search, or to have system 100 publish an advertisement for the search to outside search parties. Alternatively, the requestor supplies the prior art documents to be submitted, in which case no search is to be performed. Accordingly, if the requestor supplies the prior art documents, steps 203 through 206 may be skipped.

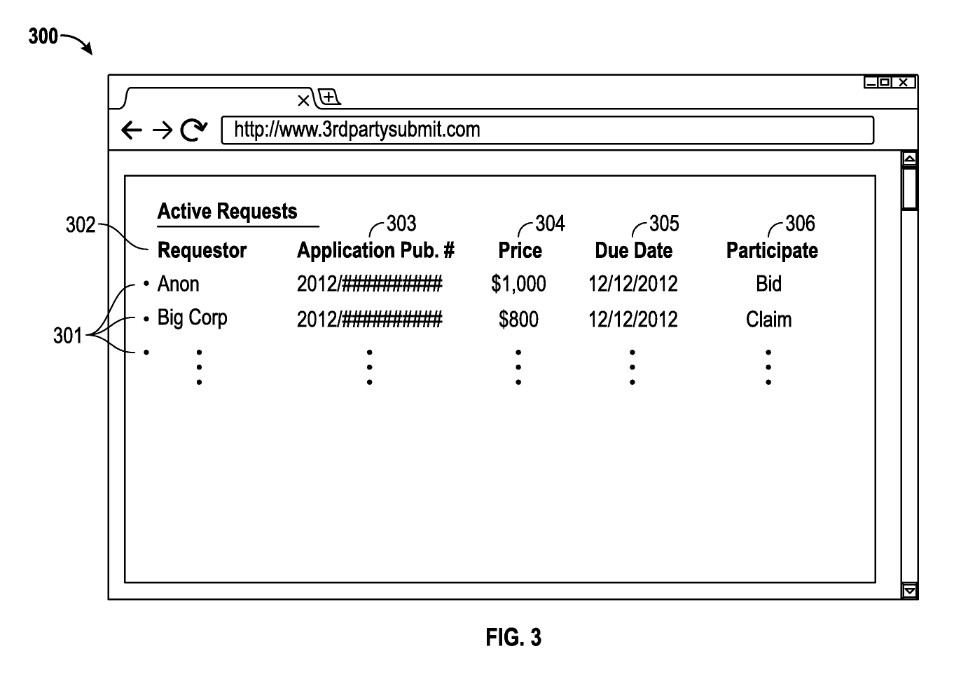

If the requestor does not designate a specific search party or indicates system 100 is to locate a search party, the search is advertised to outside search parties (step 204). Referring to FIG. 3, a listing is published on system website 300. The listing serves as an advertisement of the search request to outside search parties. Website 300 includes a listing of active search requests. Website 300 is accessible to outside search parties such that search parties can locate and claim search requests. In order to claim an active search request, a search party first registers with system 100. Registration with system 100 may include a membership fee. The membership fee may be a one-time payment or a recurring payment (e.g., monthly, annually, or per search request). An individual third-party search request is posted as listing 301. Listing 301 includes requestor identification 302. A requestor may choose to remain anonymous, in which case website 300 indicates the requestor as being anonymous (shown as “anon” in FIG. 3). Listing 301 includes patent application publication number 303, price 304, and due date 305. Further, listing 301 includes participation option 306 for the viewing search party. Participation option 306 defines how a search party is to claim the search. For example, the requestor can designate a set fee such that a search party claims a listing for the set fee. Accordingly, the search party may be paid the set fee. Alternatively, the requestor designates an auction scenario in which the request indicates a maximum price and competing search parties bid down the price of the search request such that the requestor may select the search party with the cheapest or lowest bid. In yet another alternate scenario, a requestor indicates that multiple search parties are to participate in a search, thereby improving the number of searchers seeking prior art. In any case, once listing 301 is claimed by a search party (or a designated number of search parties), system 100 deactivates listing 301. Listings are organized on website 300 by technology area, requestor, assignee of the target application, inventor of the target application, due date, price, or in any other fashion. In any listing format, an acceptance or acknowledgment is transmitted to the committing search party or parties, or in the case of an auction, to the winning bidder. Further, once the requirements of the listing are satisfied, system 100 indicates that the listing is fulfilled, removes the listing, and/or publishes a withdrawal of the listing.

If the requestor designates a specific search party, system 100 is configured to provide the designated search party a search request. The search request includes the target patent application publication number, search instructions, as well as any other information necessary for the search party to perform the prior art search (e.g., amendments or patent office communication gathered during step 202).

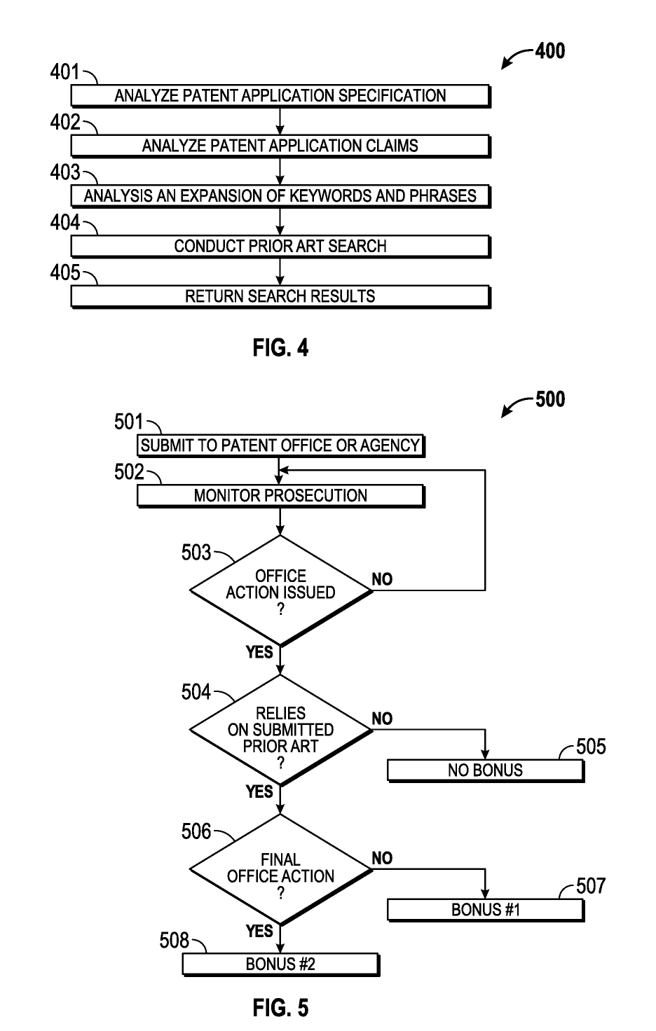

If the requestor indicates that system 100 is to perform an automated prior art search, system 100 performs a keyword search in prior art databases 105. Referring to FIG. 4, a method 400 of performing an automated prior art search is shown according to an exemplary embodiment. The target patent application's specification is analyzed for keywords and phrases (step 401). The target patent application's claims are analyzed for keywords and phrases (step 402). The most recent set of claims are used in any system analysis, including any claim amendments. The keywords and phrases are determined based on a search algorithm. The search algorithm pulls the words and phrases that are repeated in the target patent application's specification and claims. The keywords and phrases are filtered such that common terms with little technical meaning (e.g., and, or, with, the, etc.) are removed. The listing of keywords and phrases returned during steps 401 and 402 is expanded to further refine the keywords and phrases before polling prior art databases (step 403). For example, the keywords and phrases are further analyzed to include synonyms from a thesaurus (e.g., Thesaurus of Claim Construction (Robert C. Kahrl, Stuart B. Soffer)), and/or any pertinent claim construction rulings (e.g., rulings made by the Patent Trial and Appeal Board or a court). A prior art search is conducted based on the keywords and phrases (step 404). The prior art search utilizes any database or combination of databases, including, but not limited to, United States and foreign patent application and patent databases, databases containing scholarly articles, databases containing company press releases, databases containing scientific journals, and/or databases containing other media publications (e.g., prior art databases 105). The prior art search may be limited to published patent applications or patents having the same classification as the target patent application. The automated search returns a set of search results that contain some or all of the searched keywords and phrases (step 405). In some situations where both an internal keyword and phrase search is performed and an outside search party is contracted for the search, the keywords and phrases may be provided to the outside search party for manual searching or further automated searching.

Referring back to FIG. 2, search results are returned to system 100 for analysis (step 207). The search result information is received from an outside search party, from an internal automated search, or from the requestor. The search results contain information pertaining to a listing of potential prior art documents, including, but not limited to, U.S. patents, U.S. patent application publications, foreign patents, foreign applications, non-patent literature, and any other prior art information. It is contemplated that prior art information is received from multiple sources (e.g., from two different outside search parties and/or from an internal search). The information from the multiple sources may be combined and later analyzed together. As an initial step, system 100 is configured to poll the USPTO or other patent entity servers (e.g., patent office servers 106) to determine any already cited prior art references in the prosecution history of the target patent application. If the returned search results include any prior art documents that have already been cited, the already cited documents are excluded from consideration for the submission. Analysis is performed only on the remaining prior art documents. The analysis (step 207) includes ranking the returned documents based on an algorithm that determines which documents are most relevant to the claims being prosecuted for the target patent application. The algorithm compares keywords and phrases in the target application's claim language against the keywords and phrases of the returned documents to determine which prior art documents most closely correlate or relate to the target application and the claims of the target application. Alternatively, at the option of the requestor, the listing of potential prior art documents is analyzed and ranked by a human. In alternate embodiment, the listing of documents is returned to the requestor for ranking. The ranking of the returned listing of prior art documents enables the listing to be reduced in size.

Analysis step 207 further includes an examiner and art unit history analysis step. Both the patent examiner assigned to examine the target application, as well as the art unit to which the patent examiner belongs, may have identifiable tendencies or policies regarding the usage of prior art. The USPTO or other patent entity servers (e.g., patent office servers) are polled to locate office actions and communications from the assigned patent examiner and art unit. All previously published office actions containing prior art rejections of claims pertaining to the assigned patent examiner and art unit are retrieved. Alternatively, a designated number of office actions or office actions corresponding to a particular time period are retrieved. Trends and tendencies how prior art references are cited and relied upon by the assigned examiner and art unit are identified. Trends include the types of prior art references cited. For example, system 100 may determine that a particular patent examiner has the tendency to only rely on patents in making claim rejections, and not foreign references, media publications, or patent application publications. The prior art documents' ranking is adjusted to exclude potential prior art references that will not be considered by the examiner based on discovered tendencies and trends.

After the ranking, examiner history analysis, and art unit history analysis, a ranked listing of potential prior art documents is returned to system 100. The ranked listing may include information pertaining to more references than are to be submitted to the patent office or agency. Accordingly, system 100 continues the submission process for only the desired number of documents to be submitted. For example, a requestor indicates to system 100 that three prior art references are to be submitted to the USPTO or other patent entity for a target application, but the ranked list includes ten potential prior art references. Accordingly, system 100 is configured to proceed with the submission based only on the top three ranked references from the listing. Further, system 100 may set a threshold ranking or relevancy for submitted prior art documents and information such that certain returned documents and information may be rejected by the system for not exceeding the threshold. For example, during analysis, system 100 may mark a prior art document or information as not relevant enough to the claims of the target patent application, and may reject the prior art document or information such that it is not ultimately submitted to the patent office. Thus, information pertaining to the desired number of quality documents are ultimately submitted even in situations where a larger than desired number of documents are returned during the prior art search.

System 100 is configured to create a virtual representation mapping the search results to the claim language of the application during analysis (step 207). Claim elements from the target application are matched with specific portions of individual prior art documents remaining from the returned search results. The virtual representation points to specific portions of a reference that potentially discloses the claimed feature. Based on the representation, a score is generated indicating the strength or probability of success of the prior art submission. For example, if the virtual representation shows each claim element and phrase lining up with a prior art document, then the strength of the submission is high. If the virtual representation of the claim indicates that many claim elements are not found in the prior art, then the strength of the submission is low. The strength can be judged on a numeric scale (e.g., “one to ten,” with ten being high and one being low) or an arbitrary scale (e.g., “high, medium, low”). Both the indication of the strength of the submission and the virtual representation mapping the claim elements of the target application with the prior art documents are returned to the requestor for analysis. Alternatively, a previously prepared third-party submission is submitted by a third-party for evaluation. In this case, a strength indication and a probability of success is generated and returned to the third-party to assist the third-party in determining whether the submission will be effective.

Further referring to FIG. 2, all necessary and required components for filing with the patent office or agency are packaged (step 208). The rules for third-party prior art submissions may vary from country to country as well as with time. For example, third-party submissions to the USPTO include: (1) a document list identifying what is being submitted, (2) a concise statement of relevance of each identified document on the list, (3) a copy of all non-U.S. patents and applications, (4) English translations of any foreign language documents, and (5) a statement that the third-party requestor does not have a duty to disclose information under 37 C.F.R. § 1.56 and that the submission complies with 35 U.S.C. § 122(e). Accordingly, system 100 automatically generates each required submission element. System 100 is configured to generate the document list, copies of all required documents, a machine English translation of any foreign language documents, and the required third-party statements.

Further, system 100 is configured to generate relevance information, including a concise statement of relevance for each prior art document. System 100 utilizes an algorithm that matches portions of the text of the prior art documents with claim language of the target patent application. In order to perform the matching, system 100 first processes each claim of the target patent application to identify each claim element. The claim element can be a single word or a phrase. System 100 is configured to remove words with little or no significant technical meaning (e.g., the words a, the, and, etc.). After identifying claim elements, system 100 matches the identified claim element to a portion of a prior art document. System 100 may utilize a thesaurus or a technical dictionary to cross-reference claim elements with language having a similar meaning. For example, if a claim requires a fastener, system 100 is operable to identify portions of prior art documents having similar meanings, such as screws, nails, and glue. Accordingly, system 100 matches the claim elements with the pertinent portions of the identified prior art references. The pertinent portion of the prior art references are then input into a statement of relevance template. The template is a chart with claim language in one column and prior art citations in another column. Alternatively, system 100 generates a series of sentences and paragraphs indicating the pertinent portions of each prior art reference. In either case, the relevance of each prior art document that is to be submitted is identified in a manner that is acceptable by the patent office or agency. In an alternative embodiment, a person provides the concise statement of relevance. The person can be the search party, the requestor, or another individual affiliated with system 100.

The above referenced required components relate to a third-party submission to the USPTO. It should be understood that system 100 can be adapted to provide third-party submissions to another nation's patent office or agency. System 100 is modifiable to provide any additional or amended forms should the United States amend its rules and fee schedule for third-party submissions. After the documents are created and/or received, system 100 is configured to package and prepare the documents for submission.

The packaged documents are sent to the requestor for approval (step 209). System 100 is configured to notify the requestor that the package is ready for approval. The notification is an e-mail containing a link to an online user interface where the requestor can view information pertaining to the packaged documents online and images or files of the packaged documents. Alternatively, a copy of the packaged documents is sent to the requestor through e-mail or postal mail. During the approval process, the requestor analyzes each document and form to ensure accuracy and make necessary modifications. If necessary, the requestor can edit documents online through the user interface or make changes to printed copies and return the copies to the system operator. The requestor signs any documents requiring signature during the review period. In certain situations, the requestor may waive step 209, such that no approval is needed prior to system 100 filing the package with the patent office or agency (step 210). In this situation, the requestor pre-signs any required forms. After necessary changes and signatures are made, the requestor returns the approved package back to system 100 for submission. It is further contemplated that the requestor wishes to remain anonymous. In this case, a submitter submitting on behalf of the requestor makes the required statements and signs any forms. Accordingly, an individual or a shell company other than the requestor is arranged to make the required statements and sign the appropriate forms. The individual may be a member of a shell company created by system 100 at the request of the requestor. An additional fee may be charged to the requestor for choosing to remain anonymous.

After system 100 receives the requestor's approval or has prior permission to bypass the approval process, the packaged set of documents and any necessary information pertaining to the packaged set of documents are filed with the USPTO or other patent entity (step 210). System 100 is configured to automatically pay any required fees with the submission. Delivery is performed through the patent office or agency's online filing system (e.g., through patent office servers 106). Alternatively, the delivery is made through mail or by personal delivery by an agent of system 100. After a successful submission, a confirmation indicating that the package was successfully delivered is sent to the requestor. The confirmation includes a copy of the final submission as well as a receipt for any fees paid to the USPTO associated with the filing. The confirmation is via e-mail or postal mail. Alternatively, the requestor makes delivery. In this case, the requestor keeps the packaged documents and personally submits the package to the patent office or agency and system 100 does not provide a confirmation.

All fees are calculated, collected from the requestor, and appropriate portions of the collected fees are distributed to the search parties (step 211). The fees from the requestor may include any of the following: a posting fee, an advertising fee, patent office or agency filing fees, a search fee, and any other additional fees. It is contemplated that the requestor pre-pay for any requested services. If a requestor pre-pays for search and submission services, the fee paid up front is kept in escrow until the case issues or abandons. Any fee collected and held in escrow may be refunded or paid out to the searching party in whole or in part based on future prosecution results and any bonus arrangements made with the searching parties. Alternatively, it is contemplated that the requestor receives periodic bills for services. The fees collected from the requestor are adjusted based on the determined strength or probability of success of the third-party submission. Alternatively, fees are collected from the requestor only if a prior art document appearing in the submission is relied upon by the patent examiner assigned to the target application. The owner or operator of system 100 retains a portion of the collected fees is retained as the posting fee and the advertising fee. Further, the owner or operator of system 100 retains a commission for locating a search party for the requestor. The commission is based on a percentage of the fee to be paid to the search party and represents a finder's fee. Alternatively the finder's fee commission is a flat fee. The appropriate portions of collected fees are distributed to the search parties.

The payment to the search party may be adjusted based on an assessment of the prior art documents returned by the search party. The assessment is based on poor results in the patent office, the quantity of returned prior art documents, a human review of the returned prior art documents, a comparison of keywords within the returned prior art to keywords within the target patent application to determine a relevance factor of the returned prior art to the target patent application, or any other factor tending to show the quality of the search party's search results. In the event the search party is paid less than the agreed upon price due to poor search results, the requestor is issued a partial refund or credit towards a future third-party submission. If the requestor did not pre-pay for services, the bill sent to the requestor is adjusted to account for the refund.

Referring to FIG. 5, a method 500 for monitoring prosecution and awarding a bonus is shown according to an exemplary embodiment. A search party may be awarded a bonus based on future prosecution results in the patent office or agency. For example, a requestor may indicate that a search party is to be paid an award for positive results. Alternatively, search parties may be rewarded independently from any input from requestors. Upon submission of a third-party prior art submission to a patent office or agency (step 501), the prosecution of the target patent application is monitored (step 502). Monitoring determines whether a new office action was issued by the patent office or agency (step 503). In the event no new no office action is detected, prosecution of the target patent application is monitored (step 502) until the application issues as a patent or goes abandoned. If a new office action is detected, the office action is analyzed to determine whether the office action includes a rejection relying on the prior art discovered by the search party (step 504). If the office action does not contain a rejection relying on the submitted prior art documents, no bonus is paid (step 505) and prosecution is monitored for future office actions. If the rejection relies on prior art submitted during step 501, a bonus is paid to the search party (step 507, step 508). The amount of the bonus depends on the finality of the office action. Accordingly, the finality of the office action is determined (step 506). If the office action is non-final, the search party is paid a first bonus (step 507). If the office action is final, the search party is paid a second bonus (step 508). The second bonus is greater in value than the first bonus. The size of the bonus also depends on whether the application goes abandoned, whether claims were rejected under a single-reference (e.g., under 35 U.S.C. 102), whether the claims were rejected under a multi-reference rejection (e.g., under 35 U.S.C. § 103), whether the submitted prior art reference is a primary reference or a secondary reference in a multi-reference rejection, whether the claims were rejected under both a single-reference and a multi-reference rejection, whether the case goes to appeal based on the submitted prior art, and the percentage of claims rejected under the prior art submitted. Monitoring of the target patent application's prosecution continues until the target patent application is abandoned or issues as a patent.

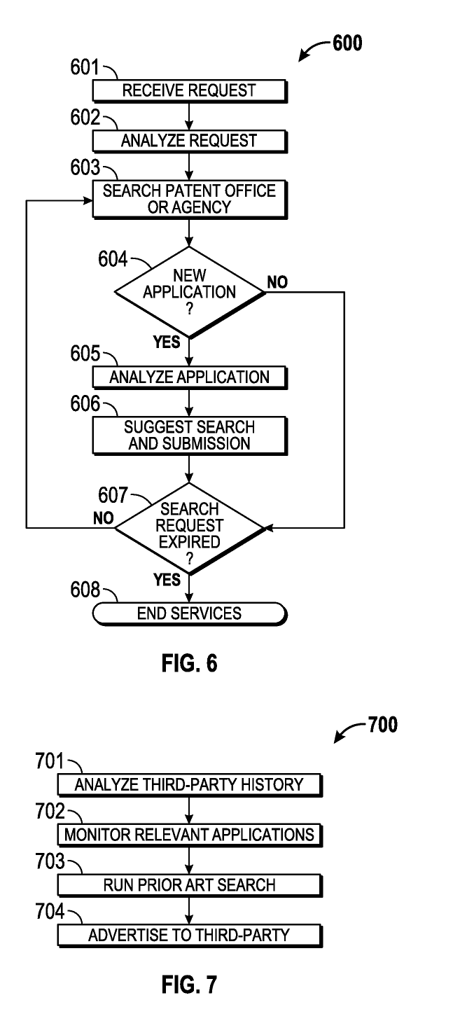

Referring to FIG. 6, a method 600 for monitoring patent application publications is shown according to an exemplary embodiment. A third-party initiates a request to monitor patent office or agency servers for newly-published patent applications (step 601). The request includes instructions to monitor for newly-published applications from a specific inventor, for a specific assignee, for a specific technology area, for a specific patent office or agency group (e.g., a specific USPTO art unit), and/or by a keyword or phrase. The request also includes a frequency of the monitoring and a duration of the monitoring. For example, a system (e.g., system 100) can be instructed to search for newly-published applications on a daily, weekly, or monthly basis for the next two years.

The request is analyzed (step 602). The analysis includes identifying what classifications of patent application publications are to be monitored and how often. USPTO or other patent entity servers (e.g., patent office servers 106) are searched for published applications (step 603). After searching the patent office or agency servers, the existence of newly-published patent applications meeting the requestor's search criteria exist is determined (step 604). If a matching newly-published patent application exists, the newly-published application is analyzed (step 605). The analysis includes extracting keywords and phrases to assist with identifying the technology area, performing an ownership interest assignment search, locating any amended claims, gathering patent office or agency prosecution correspondence, and any other related analysis. The requestor is alerted of the new application and to recommend a prior art search and third-party submission (step 606). After alerting the requestor of matching patent application publications, or if no matching newly-published patent applications were returned in step 604, the expiration of the search request is determined (step 607). The search request expires based on the time frame designated in the initial request. If the search request is not expired, an additional search for matching newly-published patent applications is performed (step 603). If the search request is expired, the process stops and no further searching is performed (step 608).

Referring to FIG. 7, a method 700 of advertising prior art searches and third-party submission service is shown according to an exemplary embodiment. Method 700 is similar to the above-discussed method 600. However, method 700 does not require a request from a requestor (step 601). Instead, a third-party is alerted about the existence of newly-published patent applications that may interest the third-party based on the third-party's prior submissions, actions, product-line, or industry. First, a category of target patent applications is determined (step 701). Then, patent office or agency servers (e.g., patent office servers 106) are regularly monitored for newly-published patent applications within the category (step 702). For example, a third-party previously ordered searches and submissions through an automated system for submitting prior art to a patent office (e.g., system 100), and the submissions pertained to patent applications invented by Inventor X, dealing with Technology Y, or assigned to Company Z. Accordingly, regular searches are performed to identify newly-published applications submitted by Inventor X, pertaining to Technology Y, or assigned to Company Z. If a newly-published patent application is found that matches the determined category, a keyword or phrase search is conducted to locate potential prior art pertaining to the discovered patent application (step 703). The keyword or phrase search is accomplished through searching prior art databases (e.g., prior art databases 105). The keyword or phrase search uses the same method and algorithm of above-reference method 200 (steps 204 and/or 205). Alternatively, an outside search party is hired to perform the search. The outside search party may be hired in the same manner as described above with respect to method 400 (The third-party is alerted to the existence of the newly-published patent application (step 704). However, the alert does not include the specific identity of the patent application. The third-party alert serves as an advertisement for search and submission services and suggests ordering a prior art search and a prior art submission for the application. Further, the alert to the third-party includes an indication that relevant prior art documents exist. In order for the prior third-party requestor to view the specific patent application identity and the located prior art documents, the prior third-party requestor would need to purchase the search and submission services.

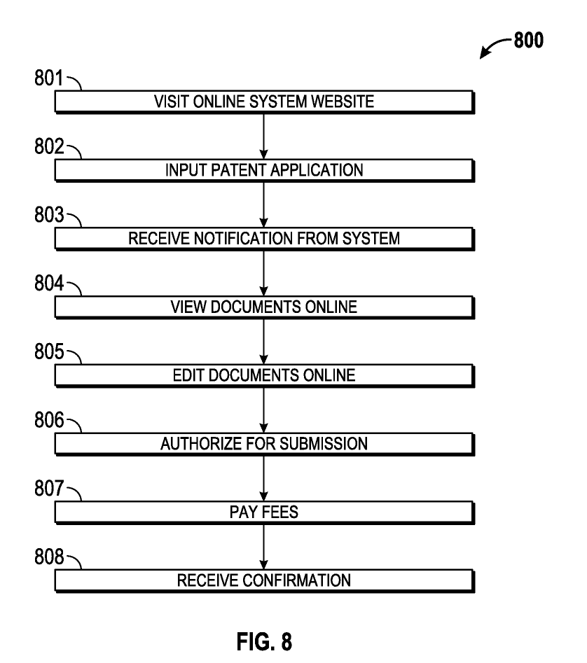

Referring to FIG. 8, a method 800 of using an automated system (e.g., system 100) for generating and submitting third-party prior art submissions to a patent office or agency is shown. A requestor initiates the online third-party search and submission process by visiting the website of a system (step 801). The website includes a graphical user interface to facilitate the requestor's submission (e.g., submission received during step 201). The website allows the requestor to designate a target patent application and select various options including search type and thoroughness. The requestor provides a target patent application to the system through the website (step 802). The requestor provides a patent application serial number, a patent application publication number, or any other reference that functions to identify the target patent application. After submitting the target patent application (step 802), the requestor receives a notification from the system indicating that a package is ready for review (step 803). The package includes returned prior art documents, statements of relevance, submission strength calculations, submission success probability, a mapping representation that lines up claim elements with the prior art documents, required forms, and a summary of the required fees. The package is viewed online through the system website. The requestor reviews the packaged documents online (step 804). Alternatively, the requestor reviews printed copies of the packaged documents. If changes to any of the documents are needed, the requestor edits the documents through the system website (step 805). After any changes are made and all forms requiring signature are signed, the requestor authorizes the package for submission (step 806). The requestor also pays any required fees (step 807). The system website is configured such that the requestor can provide a credit card number or bank account and bank routing numbers to facilitate payment. After payment is made and the packaged documents were submitted to the patent office or agency, the requestor receives an automated confirmation from the system. The confirmation can be through e-mail, postal mail, or instantaneously displayed on the system website.

The above described processes and methods associated with FIG. 1 through FIG. 8 can be contained and executed by various computing modules. The modules may include one or more computing devices such as a processor (e.g., a microprocessor), a central processing unit (CPU), a digital signal processor (DSP), an application-specific integrated circuit (ASIC), a field programmable gate array (FPGA), and the like, or any combinations thereof. Further the modules can include discrete digital or analog circuit elements or electronics, or combinations there of In an embodiment, a module includes one or more ASICs having a plurality of predefined logic components. In an embodiment, a module includes one or more FPGAs, each having a plurality of programmable logic components.

In an embodiment, a module includes circuitry having one or more components operably coupled (e.g., communicatively, electromagnetically, magnetically, ultrasonically, optically, inductively, electrically, capacitively coupled, and the like) to each other. In an embodiment, a module includes one or more remotely located components. In an embodiment, remotely located components are operably coupled, for example, via wireless communication. In an embodiment, remotely located components are operably coupled, for example, via one or more receivers, transmitters, transceivers, and the like. In an embodiment, the third-party request module is operably coupled to a module having one or more routines, components, data structures, interfaces, and the like.

In an embodiment, a module includes memory that, for example, stores instructions or information. For example, in an embodiment, at least one control module includes memory that stores object identification information, object classification information, and object characterization information, and the like. Non-limiting examples of memory include volatile memory (e.g., Random Access Memory (RAM), Dynamic Random Access Memory (DRAM), and the like), non-volatile memory (e.g., Read-Only Memory (ROM), Electrically Erasable Programmable Read-Only Memory (EEPROM), Compact Disc Read-Only Memory (CD-ROM), and the like), persistent memory, and the like. Further non-limiting examples of memory include Erasable Programmable Read-Only Memory (EPROM), flash memory, and the like. In an embodiment, the memory is coupled to, for example, one or more computing devices by one or more instructions, information, or power buses. For example, in an embodiment, the third-party request module includes memory that, for example, stores object identification information, object classification information, object characterization information, and the like.

In an embodiment, a module includes one or more computer-readable media drives, interface sockets, Universal Serial Bus (USB) ports, memory card slots, and the like, and one or more input/output components such as, for example, a graphical user interface, a display, a keyboard, a keypad, a trackball, a joystick, a touch-screen, a mouse, a switch, a dial, and the like, and any other peripheral device. In an embodiment, a module includes one or more user input/output components that are operably coupled to at least one computing device configured to control (electrical, electromechanical, software-implemented, firmware-implemented, or other control, or combinations thereof) at least one parameter associated with, for example, to receive a request from a third-party through a website, the request identifying at least one target patent application.

In an embodiment, a module includes a computer-readable media drive or memory slot that is configured to accept signal-bearing medium (e.g., computer-readable memory media, computer-readable recording media, and the like). In an embodiment, a program for causing a system to execute any of the disclosed methods can be stored on, for example, a computer-readable recording medium (CRMM), a signal-bearing medium, and the like. Non-limiting examples of signal-bearing media include a recordable type medium such as a magnetic tape, floppy disk, a hard disk drive, a Compact Disc (CD), a Digital Video Disk (DVD), Blu-Ray Disc, a digital tape, a computer memory, and the like, as well as transmission type medium such as a digital or an analog communication medium (e.g., a fiber optic cable, a waveguide, a wired communications link, a wireless communication link (e.g., receiver, transmitter, transceiver, transmission logic, reception logic, etc.).) Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, and the like.

For example, it is contemplated that the memory includes a third-party request module. The third-party request module includes circuitry configured to receive the above discussed third-party request that identifies a target patent application through a website. The third-party request circuitry is further configured to perform any of the above described methods and processes associated with receiving and analyzing a third-party request. Further, the memory includes a solicitation module that includes circuitry configured to publish an online posting relating to the target patent application, and circuitry configured to receive an indication from a search party indicating that the search party will perform a prior art search. The solicitation module circuitry is further configured to perform any of the above described methods and processes associated with interacting with an outside search party. The memory further includes a submission module including a circuitry configured to receive prior art information from the search party. The submission module further includes circuitry configured to generate electronic submission information to a patent office, wherein the electronic submission information includes at least one of prior art information and relevance information. The submission module circuitry is further configured to perform any of the above described methods and processes associated with analyzing prior art, analyzing target patent applications, generating required forms, and interacting with the patent office or agency. It should be understood that the any of the above described processes and methods relating to FIG. 1 through FIG. 8 can be incorporated into one of the above three described modules or into a separate module.

It should be understood that although the above described embodiments relate to an automated, online system (e.g., system 100), the systems and methods described above are capable of being operated out of brick-and-mortar locations. Accordingly, in an alternate embodiment, the system and method for facilitating third-party art submissions is operated out of a physical, brick-and-mortar location. In this case, the system is utilized by an agency having a physical office staffed with employees. A third-party requestor physically submits a search and submission request to begin the search and submission process. Alternatively, the third-party requestor submits the request via telephone, e-mail, or an online form to begin the search and submission process. The brick-and-mortar agency employs similar network connections with search parties, customer third-parties, and patent office or agency servers, as system 100. Alternatively, the brick-and-mortar agency employs individuals that personally contact, reach out to, or deliver materials to any search parties and the patent offices or agencies.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, and in any of a wide variety of colors, textures, and combinations. Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word “exemplary” is intended to present concepts in a concrete manner. Accordingly, all such modifications are intended to be included within the scope of the present inventions. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps, and decision steps.

1. A system, comprising:
a third-party request module including circuitry configured to receive a request from a third-party, the request identifies a target patent application;
a solicitation module including circuitry configured to publish an advertisement relating to the target patent application, and circuitry configured to receive an indication from a search party that the search party will perform an art search;
a submission module including circuitry configured to receive reference information from the search party, and circuitry configured to generate electronic submission information and to transmit the electronic submission information to a patent office, wherein the electronic submission information includes at least one of reference information and relevance information.

2. The system of claim 1 wherein the submission module further includes circuitry configured to receive relevance information from the third-party.

3. The system of claim 1 wherein the submission module further includes circuitry configured to receive relevance information from the search party.

4. (canceled)

5. The system of claim 1 wherein the submission module further includes circuitry configured to send the electronic submission information to the third-party for approval.

6. The system of claim 5 wherein the submission module further includes circuitry configured to receive an indication of approval from the third-party.

7. (canceled)

8. (canceled)

9. The system of claim 8 wherein the submission module further includes circuitry configured to return a portion of the fee to the third-party.

10. (canceled)

11. Non-transitory tangible computer-readable storage media with computer-executable instructions embodied thereon that when executed by a computing system perform a method of facilitating a third-party prior art submission to a patent office, the media comprising:
instructions for receiving request information from a third-party, wherein the request identifies a target patent application;
instructions for generating search request information relating to the target patent application;
instructions for receiving an indication from a search party that the search party will perform an art search;
instructions for receiving reference information from the search party; and
instructions for generating electronic submission information for transmission to the patent office, the electronic submission information includes at least one of prior art information and relevance information.

12. The computer-readable media of claim 11 further comprising instructions for receiving the relevance information from the third-party.

13. The computer-readable media of claim 11 further comprising instructions for receiving the relevance information from the search party.

14. The computer-readable media of claim 11 further comprising instructions for generating the relevance information.

15. The computer-readable media of claim 11 further comprising instructions for sending the electronic submission information to the third-party for approval.

16. The computer-readable media of claim 15 further comprising instructions for receiving an indication of approval from the third-party.

17. (canceled)

18. (canceled)

19. The computer-readable media of claim 18 further comprising instructions for returning a portion of the fee to the third-party.

20. (canceled)

21. A method of submitting third-party art submissions in a patent application to a patent office, comprising:
receiving a request from a third-party, the request identifying a target patent application;
publishing an advertisement for an information search relating to the target patent application;
receiving an indication from a search party that the search party will perform the prior art search;
receiving a first information from the search party; and
submitting a set of information to the patent office, wherein the set of information includes at least the first information and a statement of relevance.

22. The method of claim 21 further comprising generating the statement of relevance.

23. The method of claim 22 wherein generating the statement of relevance includes matching language of the first information to a claim language of the target patent application.

24. The method of claim 23 further comprising creating a chart having the claim language in a first column and a citation to the matching language of the first information in a second column.

25. The method of claim 21 further comprising receiving the statement of relevance from the third-party.

26. The method of claim 21 further comprising receiving the statement of relevance from the search party.

27. (canceled)

28. (canceled)

29. (canceled)

30. The method of claim 21, further comprising transmitting an acceptance to the search party for the search party to perform the search, and publishing a withdrawal of the advertisement.

31-141. (canceled)
